(19) United States
(12) Patent Application Publication
(10) Pub. No.: US 2026/0042020 A1
(43) Pub. Date: Feb. 12, 2026

(54) DETECTING CHEATING USING MACHINE LEARNING

(71) Applicant: Roblox Corporation, San Mateo, CA (US)

(72) Inventors: Albert TANG, San Carlos, CA (US); Neslihan GULER, Palo Alto, CA (US); Tania Lorido BOTRAN, San Mateo, CA (US); Zhengyun WANG, Ithaca, NY (US)

(73) Assignee: Roblox Corporation, San Mateo, CA (US)

(21) Appl. No.: 19/051,388

(22) Filed: Feb. 12, 2025

Related U.S. Application Data
(60) Provisional application No. 63/680,424, filed on Aug. 7, 2024.

(51) Int. Cl. A63F 13/75; A63F 13/67

(52) U.S. Cl. CPC A63F 13/75; A63F 13/67; A63F 2300/5586; A63F 2300/6027

(57) ABSTRACT

Some implementations relate to methods, systems, and computer-readable media to detect cheating in a virtual experience. Game information including game state information is obtained. A trained machine learning (ML) model generates, based on the game information, output that characterizes user behaviors in a virtual experience. The output includes cheating analysis data that characterizes the user behaviors by indicating a cheating likelihood for one or more users. The game information may be preprocessed by being flattened and serialized prior to providing it to the ML model. If the cheating analysis data indicates that the user is cheating with a likelihood exceeding a threshold probability, the game server may perform an anti-cheat operation.

### CROSS-REFERENCE TO RELATED APPLICATIONS

This application claims priority to U.S. Provisional Application No. 63/680,424, entitled “DETECTING CHEATING USING MACHINE LEARNING,” filed on Aug. 7, 2024, the content of which is incorporated herein in its entirety.

### TECHNICAL FIELD

Embodiments relate generally to computer-based gaming and virtual environments, and more particularly to methods, systems, and computer-readable media to detect cheating and/or inauthentic behavior in a virtual experience or game using machine learning.

### BACKGROUND

Cheating by players is common on game and virtual experience platforms, especially when client applications report game states and data to the server. A server may accept and trust such client reports unconditionally, often without game-specific validation being implemented. For example, cheating may include a player altering various game states such as physics states, scores, owned items, and more. Such cheating may allow a player to achieve an advantageous game action or status that is not attainable through fair play.

For some gaming and/or virtual experience platforms (metaverse/virtual environments), client applications (client-side code that executes locally on a client device) may be modified arbitrarily on an untrusted user device. Hence, client-side detections of tampering may not be completely reliable. At present, such platforms lack an effective way to verify whether client-side information has been altered. Accordingly, it may be difficult for such platforms to identify cheating behavior that is enabled by a modified game client application.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations described herein relate to detecting cheating and/or inauthentic behavior in a virtual experience or game using machine learning.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to detect cheating in a virtual experience comprises: obtaining game information comprising game state information; and generating, by a trained machine learning (ML) model and based on the game information, output that characterizes user behaviors in a virtual experience, wherein the output includes cheating analysis data that characterizes the user behaviors by indicating a cheating likelihood for one or more users.

Various implementations of the computer-implemented method are described herein.

In some implementations, the trained ML model is trained using supervised learning using training data pre-generated during cheating scenarios.

In some implementations, the trained ML model is game-specific or genre-specific.

In some implementations, the cheating analysis data is associated with a confidence score.

In some implementations, the trained ML model is a single ML model that generates a plurality of labels, each label corresponding to a particular type of cheating, or the trained ML model includes a plurality of activity-specific ML models, wherein each activity-specific ML model is a respective label corresponding to a particular type of cheating.

In some implementations, the computer-implemented method further comprises preprocessing the game information prior to the generating by flattening the game information and serializing the game information into a vector of numbers.

In some implementations, the game state information comprises time data and user avatar physics data, and indicates cheating when the user avatar physics data comprises values that violate one or more physics rules of the virtual experience.

In some implementations, the cheating analysis data comprises a plurality of likelihoods, each likelihood corresponding to a particular type of cheating.

In some implementations, the cheating analysis data comprises a cheating likelihood label for each time window of a predetermined length.

In some implementations, a time window associated with a threshold number of consecutive cheat labels in the cheating analysis data, each cheat label indicating prohibited behavior, is determined as indicating prohibited behavior for the time window.

In some implementations, the computer-implemented method further includes, in response to the cheating analysis data indicating with a likelihood exceeding a threshold probability that the user is cheating, performing an anti-cheat operation.

In some implementations, the computer-implemented method further includes providing the cheating analysis data and game scripts to a language model for program synthesis to generate scripts robust to a cheat associated with the cheating analysis data.

According to another aspect, a non-transitory computer-readable medium is provided. The non-transitory computer-readable medium has instructions stored thereon that, responsive to execution by a processing device, causes the processing device to perform operations comprising: obtaining game information comprising game state information; and generating, by a trained machine learning (ML) model and based on the game information, output that characterizes user behaviors in a virtual experience, wherein the output includes cheating analysis data that characterizes the user behaviors by indicating a cheating likelihood for one or more users.

Various implementations of the non-transitory computer-readable medium are described herein.

In some implementations, the operations further comprise preprocessing the game information prior to the generating by flattening the game information and serializing the game information into a vector of numbers.

In some implementations, the operations further comprise, in response to the cheating analysis data indicating with a likelihood exceeding a threshold probability that the user is cheating, performing an anti-cheat operation.

In some implementations, the trained ML model is a single ML model that generates a plurality of labels, each label corresponding to a particular type of cheating, or the trained ML model includes a plurality of activity-specific ML models, wherein each activity-specific ML model is a respective label corresponding to a particular type of cheating.

According to another aspect, a system is disclosed, comprising: a memory with instructions stored thereon; and a processing device, coupled to the memory, the processing device configured to access the memory, wherein the instructions when executed by the processing device cause the processing device to perform operations including: obtaining game information comprising game state information; and generating, by a trained machine learning (ML) model and based on the game information, output that characterizes user behaviors in the virtual experience, wherein the output includes cheating analysis data that characterizes the user behaviors by indicating a cheating likelihood for one or more users.

Various implementations of the system are described herein.

In some implementations, the operations further comprise preprocessing the game information prior to the generating by flattening the game information and serializing the game information into a vector of numbers.

In some implementations, the operations further comprise, in response to the cheating analysis data indicating with a likelihood exceeding a threshold probability that the user is cheating, performing an anti-cheat operation.

In some implementations, the trained ML model is a single ML model that generates a plurality of labels, each label corresponding to a particular type of cheating, or the trained ML model includes a plurality of activity-specific ML models, wherein each activity-specific ML model is a respective label corresponding to a particular type of cheating.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture for providing an anti-cheat machine learning model, in accordance with some implementations.

FIG. 2 is a diagram that illustrates of managing cheating in a game session with cheating, in accordance with some implementations.

FIG. 3 is a diagram that illustrates examples of various types of cheating that may occur in a virtual experience, in accordance with some implementations.

FIG. 4 is a diagram of providing information to a machine learning model to obtain cheating analysis data, in accordance with some implementations.

FIG. 5 is a flowchart of an example method for cheat detection, in accordance with some implementations.

FIG. 6A is a diagram of providing game information to a machine learning model to obtain cheat likelihood information, in accordance with some implementations.

FIG. 6B is a diagram of providing game information to machine learning models to obtain cheat likelihood information, in accordance with some implementations.

FIG. 7 is a diagram of an example of time-series snapshot data in association with cheat probabilities, in accordance with some implementations.

FIG. 8 is a diagram of an example of training a machine learning model, in accordance with some implementations.

FIG. 9 is a diagram of an example of detecting abnormal avatar behavior as a sign of cheating, in accordance with some implementations.

FIG. 10 is a diagram of anti-cheat operations, in accordance with some implementations.

FIG. 11 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to an anti-cheat machine learning model. Such a model may be associated with an online gaming platform, such as one that provides virtual experiences in a virtual environment. In some implementations, features may include receiving user avatar states, processing the user avatar states, providing the user avatar states to a machine learning model trained to detect cheating, and obtaining information about possible cheating from the output of the machine learning model. Cheating behaviors may include behaviors in a virtual environment that are inauthentic behaviors or prohibited behaviors.

In general, a virtual environment may refer to a platform that hosts many virtual experiences by managing access to virtual experiences. The virtual experiences correspond to individual users' interactions with a platform that provides interactive games that the users can play.

Nevertheless, regardless of cheating intent, clients are required to report their local avatar's physics data to the game server so that their states get shared with other clients. Such reported data provides the opportunity to do server-side cheat detections based on reported inputs (such as reported physics data inputs) that are resilient to many forms of client-side attacks.

Machine learning may thus be leveraged to detect cheating from user avatar states, e.g., relying on physics data (and how it changes over time). For example, machine learning may consider input physics features including user avatar position, linear velocity, angular velocity, and altitude. The input features may also include user avatar-adjacent object properties, collisions, game length, play time, a number of in-game players, user cheat history, reputation, account age, and other account information, as well as characteristics of the virtual experience itself (genre, popularity, number of cheat reports, etc.).

The outputs of the machine learning may include probabilities of the user cheating, either as one variable (Cheating/Not Cheating) or multiple outputs, each associated with a particular type of cheat (Flying Likelihood, Speed Hacking Likelihood, etc.). The probabilities may be associated with snapshots at particular points in time, with windows (of a time interval including several snapshots), and/or with sessions including snapshots involved in a complete interaction between a player and the virtual environment.

In some implementations, the machine learning model may use deep learning techniques. In some implementations, the machine learning model may include at least one trained neural network. Some implementations may use a basic three-layer neural network (one input layer, one hidden layer, and one output layer). In other implementations, there may be multiple hidden layers. In addition, the features input into the machine learning model may include a plurality of snapshots that track user information (e.g., avatar state of an avatar of the user in the virtual experience) over time. Certain neural network structures are well-suited for time-series data, as discussed below. In yet other implementations, the neural networks may be convolutional neural networks (CNNs). CNNs are a type of neural networks that are regularized feed-forward neural networks that learn feature engineering, such as by filter optimization or the use of kernels.

Because the machine learning model analyzes input data that includes time-series data (e.g., values that change over time), in some implementations, the machine learning model may be a model that is specifically designed to take as input data that changes over time. Some implementations may use a machine learning model with a Recurrent neural network (RNN) architecture, a machine learning model with a Long Short-Term Memory (LSTM) architecture, or a machine learning model with a transformer architecture. These architectures may be particularly effective because they consider patterns in how data changes over time during training and when generating corresponding outputs.

In various implementations, the machine learning (ML) models may be trained using supervised and/or unsupervised learning approaches. For supervised learning, the training data may be from actual use cases (e.g., game state data for various virtual experiences, including both cheating behavior and authentic behavior) or may be synthetic data, such as hand-created synthetic data. Such synthetic data could also potentially be generated by bots (e.g., computer-generated avatars that participate in a game or virtual experience). Synthetic data may also be obtained through simulation environment or by extrapolating from real data. In some implementations, unsupervised learning may be utilized to train a ML model to identify patterns inherent to the data without pre-existing labels. Moreover, supervised and unsupervised learning may be used together in some implementations.

A trained ML model may be able to detect cheating behavior of avatars in a virtual experience. In some implementations, such a model may output binary labels for an avatar as “cheating” or “not cheating.” In some implementations, a confidence value may be associated with the output labels. In some implementations, such a model may output binary labels for an avatar for different types of cheating behavior, e.g., “Yes/No” values for each of speedhack, flying cheat, aim-bot cheat, or other types of cheating behavior. In some implementations, the model may output a respective confidence score (e.g., a value between 0 and 1) for each type of cheating behavior. For example, such a confidence score may correspond to an estimated probability that a given cheating behavior is occurring.

At inference time, when a trained ML model is deployed to detect cheating behavior, the machine learning model may output cheating likelihoods. Such likelihoods may be associated with confidence values. Based on gamer information, the machine learning models are able to identify cheating behaviors that would otherwise have gone undetected. It may also be possible to provide at least one appropriate anti-cheat response.

In some implementations, the ML model may be run in real time (e.g., while various avatars participate and engage in activity in virtual experiences). However, the ML model may also be run offline, in other implementations. Thus, the model can be used both online (real time) and offline. The anti-cheat will vary for the latter, like banning or sanctioning the client. The ML model may also be used to establish client trust, e.g., may serve as the source of truth on whether a client simulation (data received from client) is to be trusted or not. To prevent cheating behavior by a particular user in a virtual experience from affecting other users in the virtual experience, a prediction of likely cheating by the ML model may cause the server to only accept key/touch inputs (without performing corresponding actions in the virtual experience) and simulate the client behavior on the server instead (server authority). Outputs of the ML model also be consumed by the game server and dynamically send further challenges to the client to provide the integrity of the client. The ML model can be combined with feedback from a human expert to further improve the model.

For example, the ML model may only have a confidence score (or probability) of 0.5 that the client is cheating. That score is not enough by itself to classify the user as cheating, so some implementations may gather more evidence by dynamically sending more challenges to the client. For example, such challenges may characterize recent client behavior and provide additional information that would cause the confidence score to become closer to 0.0 or 1.0.

### Aspects of Chats/Exploits

In a virtual environment, an exploit or cheat may include the use of a third-party program to alter the client and the way the client interacts with a game server. Such a change may allow a player to gain an unfair advantage over others in the game. Exploits may also be used for other problematic behavior such as griefing (annoying other players or spoiling an experience) and for stealing or modifying places, models, objects, and/or scripts. Some exploits take the form of programs or injectable files. For example, the injectable files may be shared library files, such Dynamic Link Library (DLL) files, Dynamic Library (dylib) files, and/or Shared Object (so) files. These files may include executable code (functions), data, and resources, in any combinations. Such files, when introduced and activated, can cause the problematic behaviors presented above, as well as others.

Many exploits allow injection of client-side scripts to be run at a virtual location of the user. Exploits may also abuse vulnerabilities within a virtual place's use of remotes, which are objects that facilitate client-server communication. Some exploits may also include backdoors that exploiters may use for hacking. Exploits may allow exploiters to change the characteristics of the virtual world, such as an exploiter's avatar's appearance, location, orientation, physics interactions with other avatars, objects, and other assets. Exploits may also include other problematic actions in addition to merely changing the appearance of the world. For example, exploits may include adding inappropriate graphical content, sending chat content that appears to come from another user, and other behaviors that the designers of a virtual experience would not like to allow. While some implementations focus on managing physics-based exploits (e.g., illegal modifications to location, speed, etc.), some techniques described herein may be applicable for managing other types of exploits.

Exploiting sometimes refers to using glitches in the engine or in scripts to gain an unfair advantage. However, glitches are not caused by third-party modification. Instead, glitches use part of a virtual environment that may be buggy and take advantage of such bugs.

Certain approaches currently allow for anti-cheat efforts. For example, users may report abuse by other users who are breaking the rules. Certain anti-exploit scripts detect suspicious behavior and kick out/ban exploiters. Another technique that is in place is replication filtering.

Additionally, a virtual environment may use anti-tamper software to detect software interacting with the client and crash the client if it identifies badware.

There are a number of technical ways in which exploits may be implemented. In general, exploits may use workarounds to execute scripts external to the virtual environment (such as C or C++ functions). These may include Bytecode through Loadstring Function (loading raw bytecode with integrated cheats), Proto Conversion (executing scripts by integrating them into a function prototype), Wrapping (generating a fake environment and emulating the regular environment), DLL Injection (using DLL injector and overcoming safeguards), Lag switching (using intentional processing delays to allow cheats such as teleportation), Process Freezing (Pausing environment code to allow interventions), Script privilege elevation (allowing a script access to certain privileges when cheating and changing a level when not cheating), and Aimbots (forcing a hitbox to perfectly track targets).

Most of these technical approaches originate at the client-side. Hence, because client-side information cannot be trusted, detection mechanisms (such as the ML model presented herein) must use information on the server (to provide a reliable source of information). Both client and server side info can be combined for the ML model

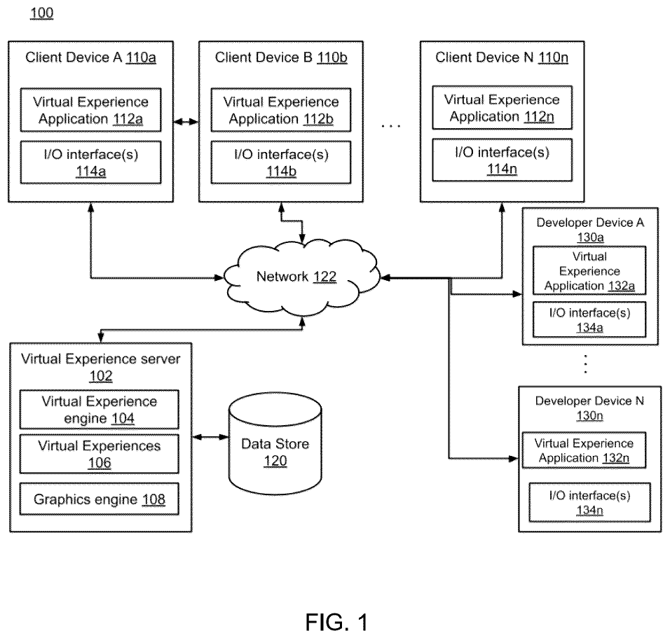

### FIG. 1—System Architecture

FIG. 1 is a diagram of an example system architecture for cheat detection in a virtual experience, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

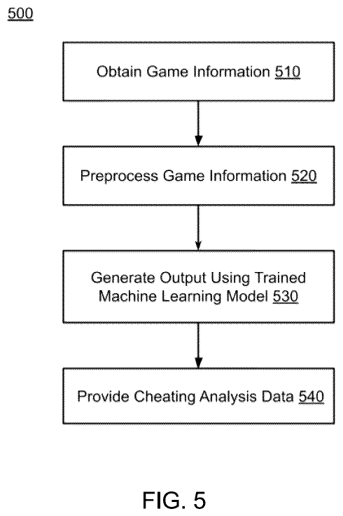

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 5. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all of the virtual experience engine functions (e.g., generate physics commands, rendering commands, etc.), or offload some or all of the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g. shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g. shirts, pants, etc. the online virtual experience platform may provide users access to simplified 3D virtual object models that are represented by a mesh of a low polygon count, e.g. between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may cach include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, cach client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

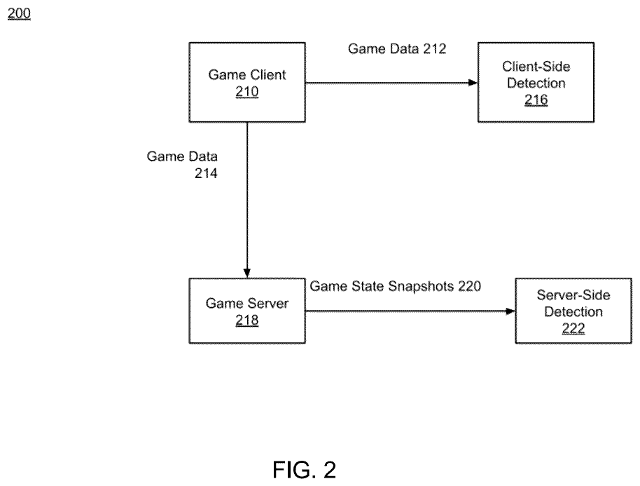

### FIG. 2—Example of Cheating in Game Session

FIG. 2 is a diagram 200 that illustrates aspects of managing cheating in a game session, in accordance with some implementations. For example, cheating may occur when a client device sends altered data to the game server. To illustrate this idea, FIG. 2 illustrates a game client 210.

Game client 210 may be in communication with game server 218. Game client 210 may send a stream of game data 212 for client-side detection 216 and may send a stream of game data 214 to game server 218. The streams of game data 212 and game data 214 may be game data as generated by game client 210, and may be used to attempt client-side detection 216 (of cheating) or may be received by game server 218. However, game clients can be modified almost arbitrarily on an untrusted user's device, which means client-side detection 216 is not completely reliable.

In some cases, stream of game data 212 may be free of cheating, and client-side detection 216 may indicate that game data 212 is reliable. However, the detected reliability is merely because the user is not trying to cheat. There may be other mechanisms to allow successful client-side detection 216 from game data 212, notwithstanding potential modifications to game client 210.

Without game state snapshots 220, cheating could go unnoticed. Game client 210 may be in communication with game server 218. Game client 210 may send game data 214 to game server 218. Because game client 210 could be modified, in this implementation, the modified game data with integrated cheating (without validation) 214 is used as the basis of game operation. The game server 218 trusts the data. The game server 218 acts on game data (with cheating) 214. Thus, the game server 218 trusts the modified game data 214 with integrated cheating (without validation) and allows the cheating behavior in the gameplay.

Hence, the game server 218 is unable to be sure that all of the data is trustworthy in the stream of game data 214. Nevertheless, regardless of cheating intent, clients have to report their local avatar's physics data to the game server so that their states get shared with other clients. This provides the opportunity to perform server-side cheat detections by focusing on information, such as physics data, that is very difficult for the game client 210 to modify, even if other aspects of the game client 210 are modified.

Hence, the game server 218 may generate game state snapshots 220. Such game state snapshots 220 provide reliable information. The game state snapshots 220 are derived on the game server 218. Because the game state snapshots 220 are derived on the game server 218 that the cheater does not have control over, the integrity of the game state snapshots 220 can be trusted.

These game state snapshots 220 are resilient to client-side attacks. It is not easy to alter these resilient game state snapshots 220, because they may be generated automatically at the game server 218 and are based on information that is resistant to modification. Hence, in some implementations, it may be possible to analyze the game state snapshots 220 to perform server-side detection 222 (of cheating). For example, individual snapshots, windows of snapshots, or complete sessions of snapshots may indicate cheating, when analyzed.

If no cheating is being attempted, the game state snapshots 220 may reinforce this at the game server 218 when the game server 218 performs server-side detection 222 and confirm “no cheating.” However, if there is cheating being attempted, the game state snapshots 220 may allow game server 218 to detect the cheating when it performs server-side detection 222. In some implementations, the cheating includes at least one of a flying cheat, an aim-bot cheat, or a speedhack cheat. Game information may include features that indicate that a particular type of cheating is being attempted. Cheating may be detected from such features. Detecting the cheating allows the game server 218 to take appropriate responsive actions.

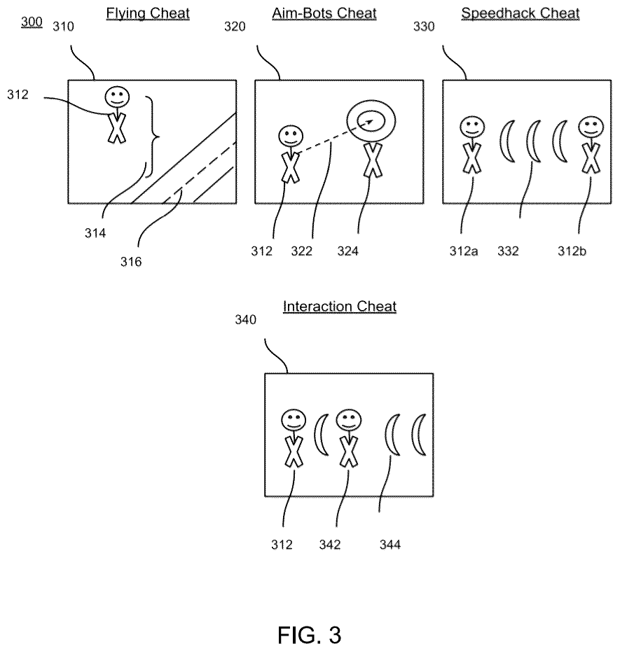

### FIG. 3—Diagram of Cheat Types

FIG. 3 is a diagram 300 that illustrates examples of various types of cheating that may occur in a virtual experience, in accordance with some implementations. For example, FIG. 3 illustrates a flying cheat 310, an aim-bots cheat 320, a speedhack cheat 330, and an interaction cheat 340. In some games or virtual experiences, other cheats may be possible (and can be detected using the techniques described herein). For example, other cheats could manipulate other aspects of game physics. However, cheats could also change other in-game attributes, such as scores, owned items, and so on. Cheats could even affect other players.

In a flying cheat 310, a player makes their avatar (in-game character) defy gravity as defined by the game physics. In a flying cheat 310 an avatar 312 moves above the ground or terrain when the game's gameplay itself does not involve any flying or floating for the characters or vehicles. FIG. 3, in flying cheat 310, illustrates avatar 312 is floating at an altitude 314 above the road 316. In the game, the avatar 312 is floating in a situation where the game anticipates that avatar 312 is on the road 316. Hence, this abnormal altitude/position may be interpreted as a sign of cheating.

Aim-bots cheats 320 may occur in a game that involves the gameplay of aiming and shooting. In such a cheat, a player manipulates that player's local client so that the player's avatar automatically and flawlessly aims at opponents before shooting. In aim-bots cheat 320, avatar 312 aims a line-of-sight 322 at target avatar 324. Aim-bots cheat 320 illustrates that this line-of-sight automatically and flawlessly allows the avatar 312 to aim at opponents before shooting. Unless such a capability is provided in-game, aiming in this way may correspond to cheating.

A possible sign of an aim-bots cheat 320 is if, whenever an avatar faces another avatar, the other avatar suddenly dies or experiences another result indicating an aim-bot, such as a drop in health or an increase in a rate of damage. For example, if avatar 312 establishes a clear line-of-sight 322 to target avatar 324 and target avatar 324 suddenly dies, this behavior may indicate an aim-bots cheat 320.

In a speedhack cheat 330, the player cheats by allowing a player to move their avatar at a speed/acceleration (mostly faster) than that a game allows. For example, speedhack cheat 330 illustrates avatar 312a at a first position. Movement 332 illustrates that the avatar 312a moves to second position 312b using movement 332. For example, movement 332 may include abnormal velocity, speed, and/or acceleration, or may include in-game teleportation. These forms of movement 332 may correspond to cheating.

In an interaction cheat 340, the player cheats by interfering with the physics (or another attribute) of another player's avatar. For example, avatar 312 may be next to avatar 342. There may be a collision or an adjacency 346 that is an influence between avatar 312 and avatar 342. After the interaction, movement symbol 344 indicates that avatar 342 may be pushed off the map or teleported elsewhere.

Hence, when a user's physics information, interactions with other players' avatars, or other reliable game information indicates that physics rules or other game rules are violated, cheating is identified as occurring.

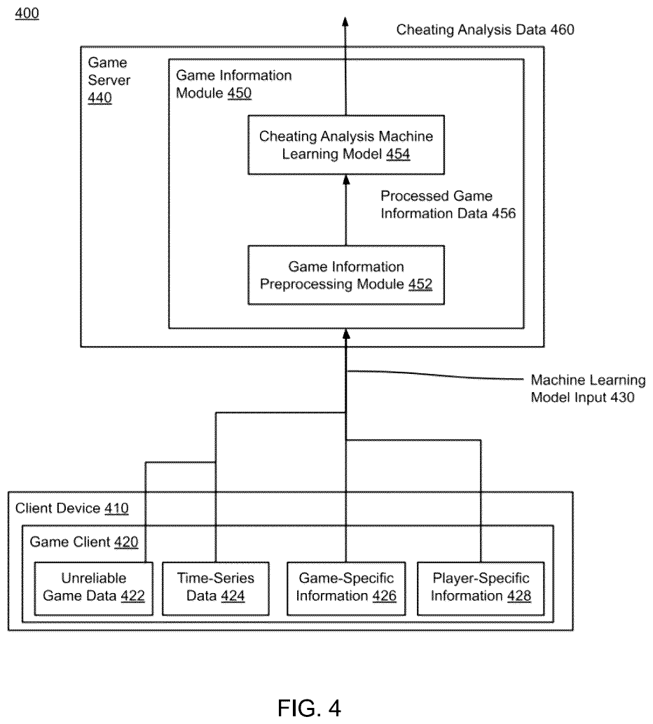

### FIG. 4—Example of Using Machine Learning to Detect Cheating

FIG. 4 is a diagram 400 of providing information to a machine learning model to obtain cheating analysis data, in accordance with some implementations. For example, FIG. 4 shows a client device 410 that is in communication with a game server 440. Client device 410 includes a game client 420. The game client 420 includes unreliable game data 422, time-series data 424, game-specific information 426, and player-specific information 428.

The unreliable game data 422 corresponds to game data provided by the client device 410. The game data may be for the use of game server 440 when the game server 440 hosts a game. Unreliable game data 422 is characterized as being unreliable because, in one attack method, a cheating user may intercept unreliable game data 422 and modify the unreliable game data 422. The unreliable game data 422 is then sent to game engine 470 which hosts the game and may lead to cheats. A cheating user may also manipulate the client device 410 or the game client 420 such that the game data is different with respect to an unmodified client. The key here is that the data is created incorrectly for a cheating user, as opposed to the data being intercepted.

While unreliable game data 422 may not actually be modified, game server 440 acts as if unreliable game data 422 is, in fact, modified. Thus, the dangers of trusting unreliable game data 422 may be ameliorated by detecting cheating by taking into account additional data from the game client 420. For example, the game client 420 may send time-series data 424, game-specific information 426, and player-specific information 428. This data is characterized as being resilient to many forms of client-side attacks. Regardless of cheating intent, clients have to report their local avatar's physics data and certain other data to the game server so that their states get shared with other clients.

Game information module 450 receives the time-series data 424, game-specific information 426, and player-specific information 428. Game information module 450 includes a game information preprocessing module 452 and a cheating analysis machine learning model 454. The game information preprocessing module 452 receives time-series data 424, game-specific information 426, and player-specific information 428 as machine learning model input 430.

The game information preprocessing module 452 is able to do at least two things with this information. The raw information includes a great deal of information. The raw information must be preprocessed so that the raw information is in a format suitable as input for machine learning (e.g., deep learning). For example, the machine learning may include various traditional machine learning techniques and/or deep learning techniques. In some implementations, the preprocessing includes flattening and/or serializing the data into integers or floating-point numbers. The preprocessing may include also reformatting the data, feature selection, and/or new feature creation (even as combinations of existing features).

For example, flattening may include taking the machine learning model input and transforming the machine learning model input into a vector. Such a transformation may be helpful because the ML model may take a vector of values as its input. Serialization means transforming an object into a format that allows the object to be communicated. Hence, the time-series data 424, game-specific information 426, and player-specific information 428 may include a complicated data structure. The game information preprocessing module 452 may transform the data into processed game information data 456 as a vector that is suitable for the ML model through such flattening and serializing.

In some implementations, the preprocessing may make it easier to isolate characteristics of the data to analyze the data. The preprocessing may also include considering the nature of the data to isolate aspects of the data that are abnormal, such as an abnormal altitude (which may indicate a flying cheat) or an abnormal linear velocity/acceleration (which may indicate a speedhack cheat).

Once the game information preprocessing module 452 is done with the data, it results in processed game information data 456 which is provided to cheating analysis machine learning model 454. After the processed game information data 456 has been preprocessed (e.g., flattened and serialized), the processed data 456 has the form of a vector of numerical inputs. Such a vector is appropriate input to the cheating analysis machine learning model 454. In some implementations, the cheating analysis machine learning model 454 uses a neural network to identify cheating patterns, and the vector of processed game information data 456 is well-suited as input to an input layer of the network. In other implementations, it may be possible to use other machine learning modeling approaches.

In some implementations, the cheating analysis machine learning model 454 may be implemented using deep learning techniques to provide a likelihood of cheating. The analysis machine learning model 454 may take on the form of a single model with multiple families/clusters of cheats, each being a label. The analysis machine learning model 454 could also be a line of models, each a binary classifier predicting whether that specific family/cluster of cheats is used. However, these are not intended as limiting, and other implementations could use other arrangements of model(s). If no cheat is predicted by the model(s), then the player is not cheating, with a certain accuracy. There might also be a specific no-cheat label. However, in some cases, the model may fail to detect cheating (false negative), or give a false positive with certain probabilities, and the model may be designed to manage these probabilities.

The cheating analysis machine learning model 454 produces cheating analysis data 460. In addition to outputting information about the likelihood of various types of cheats, the cheating analysis data 460 may be the basis of various anti-cheat steps. Such anti-cheat steps may involve recording information about cheating, interpreting the provided information, or taking active steps to control cheating.

### FIG. 5—Example Method for Cheat Detection

FIG. 5 is a flowchart of an example method 500 for cheat detection, in accordance with some implementations. In some implementations, the cheat detection involves receiving particular data that is resilient to tampering. The data may be preprocessed so that the data is in a format suitable for analysis by a trained machine learning model. The trained machine learning model may provide information about the likelihood of various types of cheating behavior, based on analyzing the data. In some implementations, the trained machine learning model is one of a recurrent neural network (RNN), a long short-term memory (LSTM) neural network, or a transformer neural network.

In block 510, game information is obtained. For example, the game information may include time-series data, game-specific information, and player-specific information. In general, the time-series data may consist of a set of snapshots of game states over time. The game states may include avatar physics information. The game-specific information and the player-specific information may stay the same throughout a session or may vary.

Such game information may be obtained from a client device. The client device may have or may provide other information as well. However, the obtained information may be information that, as discussed, has properties that cause it to suitable for anti-cheat purposes. The client device may provide other information as well. Such other information is not necessarily considered to be reliable information. Additional game information may be obtained from within the game server itself. Block 510 may be followed by block 520.

In block 520, the game information is preprocessed. For example, the game information may be flattened and serialized. When the game information is flattened and serialized, it may be transformed into a vector of values, such as integers and/or floating-point numbers. This transformation may be helpful before processing the data using the model. A vector of values is more suitable than the original game information for input to a neural network. Block 520 may be followed by block 530.

In block 530, the preprocessed game information is provided to a trained machine learning model. The ML model accordingly generates a corresponding output. The corresponding output may characterize the inputs to the model (time-series data, game-specific information, player-specific information) as indicating cheating. The ML model may also be designed to consider time-dependent aspects of the time-series data. For example, the ML model may consider cheating for individual snapshots, time windows, or entire sessions.

In some implementations, the ML model may be provided as a single model that provides a plurality of specialized outputs. The outputs may include a general likelihood of cheating and specific likelihoods of particular types of cheats. In some implementations, a plurality of ML models may be provided, each of which outputs a likelihood of a particular type of cheating. There may also be a dedicated ML model to output a general likelihood of cheating and/or a dedicated ML model to output a likelihood of no cheating.

The ML models may also associate a confidence score with each given likelihood. There may also be a first threshold and a second threshold greater than the second threshold. If the likelihood is less than or equal to the first threshold, the cheating is held not to occur. If the likelihood is greater than or equal to the second threshold, the cheating is held to occur. If the likelihood falls between the two thresholds, the cheating is held to be indeterminate or require more evidence. For example, probabilities from 0.0 to 0.25 could correspond to no cheating. Between 0.25 and 0.75 could indicate uncertainty. 0.75 to 1.0 could correspond to cheating. Block 530 may be followed by block 540.

In block 540, cheating analysis data may be provided. The cheating analysis data may be the exact result of the ML models' output (the respective likelihoods) or may be organized to give the output additional meaning. For example, the cheating analysis data could include a raw likelihood of cheating or not or could include raw likelihoods of certain types of cheats. The cheating analysis data could also include the cheat determinations and confidence scores. In some implementations, the cheating analysis data is refined and organized as a report indicating the cheat information. The report may include summary statistics or graphical representations of the cheating analysis data.

After block 540 provides the cheating analysis data, a user who receives the cheating analysis data may use the information to better understand what types of cheating may be occurring. The cheating analysis data could also be stored or further analyzed. For example, the cheating analysis data could be provided to help a human better understand if cheating is occurring. The cheating analysis data could also lead to automatic or manual anti-cheat operations.

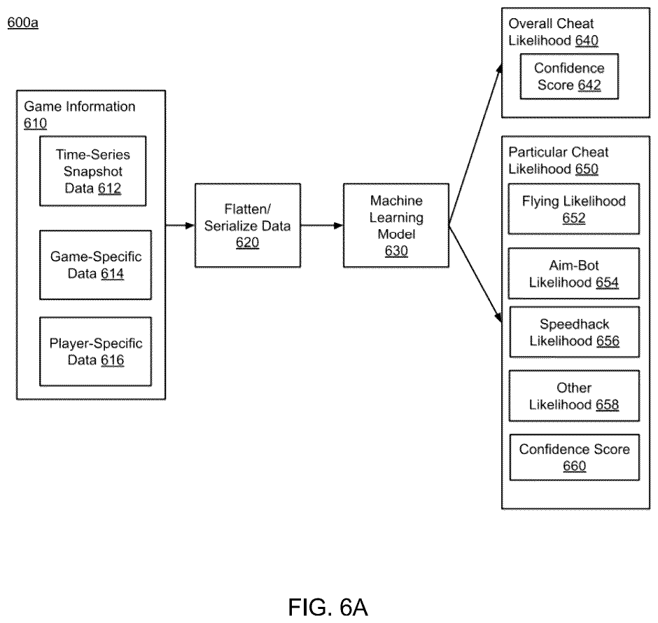

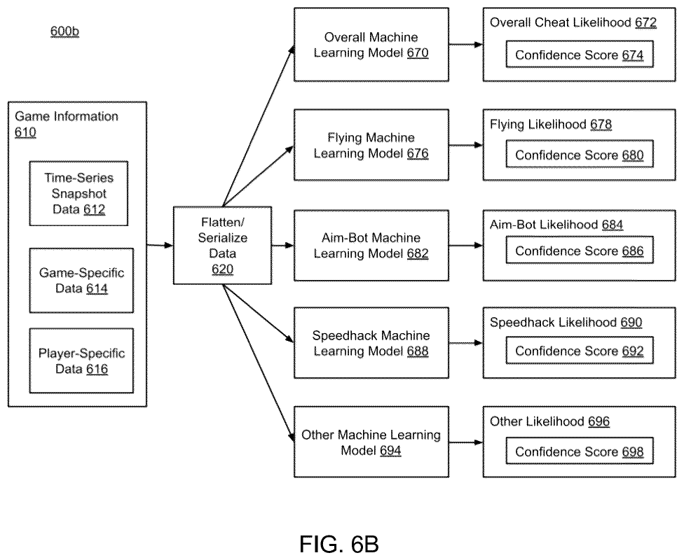

### FIG. 6A—Providing Game Information to Machine Learning Model to Detect Cheating

FIG. 6A is a diagram 600a of providing game information to a machine learning model to obtain cheat likelihood information, in accordance with some implementations. For example, the diagram 600a begins with game information 610. The game information 610 may include several types of information that are automatically reported by a client device to a game server. These types of information may include information that must be unmodified as a precondition for the game to work. Thus, the potential cheater is incentivized not to modify the data. Hence, this information is reliable. When other client-side information is abnormal or otherwise illustrates signs of tampering, the automatically provided information may be a good indicator of when a cheat is occurring, the type of cheat, the likelihood of the cheat, and a related confidence score.

For example, the game information 610 may include time-series snapshot data 612, game-specific data 614, and/or player-specific data 616. Here, the time-series snapshot data 612 includes captures of the player' s game state, captured at various time intervals (such as every 500 ms, or every couple of seconds). For example, the time-series snapshot data 612 may include time information, physics states (altitude, velocity, rotation, and acceleration, etc., at capture times). The time-series snapshot data 612 may also include other states, including character states, a facing direction, and so on. The time-series snapshot data 612 may also include information about nearby players' IDs and distances, as well as collided players' IDs and distances.

The game-specific data 614 may include information such as game genre, characteristics, and popularity. The game genre may be relevant in that some ML models are trained for particular genres. Also, the game characteristics may provide guidance about what types of observed behaviors correspond to cheating. For example, in some games, user avatars are usually on the ground. In these games, floating user avatars would likely indicate cheating. In other games, certain conditions would indicate whether floating corresponds to cheating or not. For example, floating would not indicate cheating in situations in which a user has an item that allows the user to legitimately fly above the terrain.

The player-specific data 616 may also include information about factors such as a device platform, account information, and so on. For example, a device platform may indicate a type of device used to access the virtual environment. If the client device is indicating that the user's avatar is doing something incompatible with the device platform, this behavior may indicate cheating. As another example, account information may provide information that is useful in generating cheats. For example, the account information may be associated with permissions or privileges a given user has. Such account information may help detect when users attempt to do something they are not allowed to do.

In order to prepare the game information 610 for analysis, the game information 610 is preprocessed using an operation of flattening and serializing data 620. The results of such an operation may include a vector of numbers (such as integers and/or floating-point values). The vector of numbers is provided into an input layer of machine learning model 630. In the example of FIG. 6A, there is one machine learning model 630 that is able to consider the data together.

Once the machine learning model 630 considers the data, the machine learning model 630 may produce an overall cheat likelihood 640 or a particular cheat likelihood 650. The overall cheat likelihood 640 may be associated with a confidence score 642. Here, the cheat likelihood 640 is the machine learning model 630′s determination as to how likely it is that cheating is occurring. The confidence score 642 is a measure of how confident the machine learning model 630 is that the value of cheat likelihood 640 is accurate. The confidence score 642 may be based, for example, upon a quantity and a consistency of evidence that cheating is occurring.

Additionally, the machine learning model 630 may produce at least one particular cheat likelihood 650. The at least one particular cheat likelihood 650 is a likelihood associated with a specific type of cheating. For example, the at least one particular cheat likelihood 650 may be a flying likelihood 652, an aim-bot likelihood 654, a speedhack likelihood 656, or another likelihood 658. Each of these particular cheat likelihoods may also be associated with an appropriate confidence score 660. An advantage of using a single machine learning model 630 is that it is only necessary to perform one training process.

Hence, a single model may consider multiple aspects of cheating. For example, the model may consider general cheating and particular types of cheating. The model may produce likelihoods and confidence scores. The model may consider individual snapshots, windows of snapshots, or sessions of snapshots.

### FIG. 6B—Providing Game Information to Machine Learning Models to Detect Cheating

FIG. 6B is a diagram 600b of providing game information to machine learning models to obtain cheat likelihood information, in accordance with some implementations. In FIG. 6B, the game information 610 includes the same constituent information, such as time-series snapshot data 612, game-specific data 614, and/or player-specific data 616. Likewise, the game information 610 is transformed into flattened and serialized data 620 in a similar manner.

However, the preprocessed data, instead of being sent together to a single, unified machine learning model, may be sent to specialized machine learning models. Each of these machine learning models is specifically trained to detect a particular type of cheat. For example, there may be an overall machine learning model 670. The task of such a model is to detect an overall cheat likelihood 672 and associate the overall cheat likelihood 672 with a corresponding confidence score 674.

Further, there may be a flying machine learning model 676. The task of such a model is to detect a flying likelihood 678 and associate the flying likelihood 678 with a corresponding confidence score 680. Additionally, there may be an aim-bot machine learning model 682. The task of such a model is to detect an aim-bot likelihood 684 and associate the aim-bot likelihood 684 with a corresponding confidence score 686. Further, there may be a speedhack machine learning model 688. The task of such a model is to detect a speedhack likelihood 690 and associate the speedhack likelihood 690 with a corresponding confidence score 692. Further, there may be other machine learning models 694. The task of such a model is to detect other likelihood 696 and associate the other likelihood 696 with a corresponding confidence score 698. An advantage of using individual machine learning models is that it may be possible to optimize their performance on a cheat-by-cheat basis, based on characteristics and attributes of particular varieties of cheating.

Multiple models may each consider a particular aspect of cheating. For example, one model may consider general cheating, while others may consider particular types of cheating. The models may produce likelihoods and confidence scores. The models may also consider individual snapshots, windows of snapshots, or sessions of snapshots.

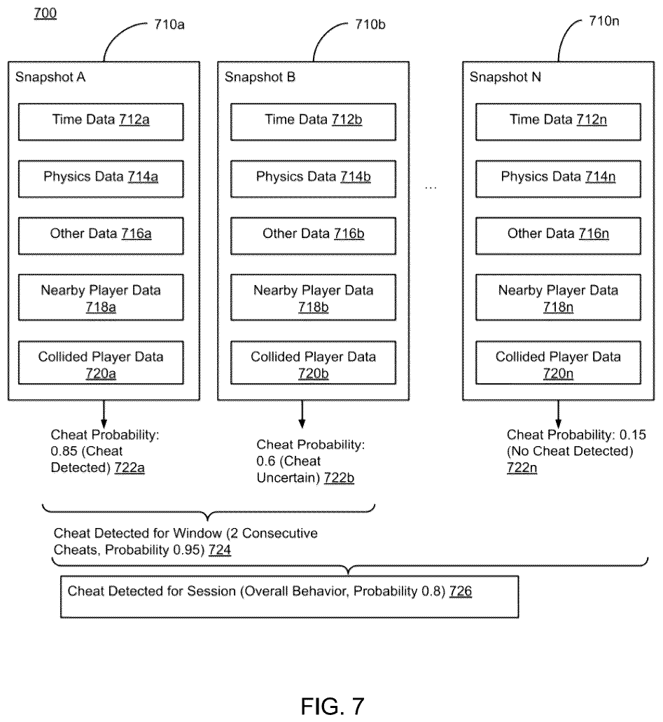

### FIG. 7—Example of Time-series Snapshot Data

FIG. 7 is a diagram 700 of an example of time-series snapshot data in association with cheat probabilities, in accordance with some implementations. For example, FIG. 7 illustrates snapshot A 710a, snapshot B 710b, through snapshot N 710n. Hence, there are a total of n snapshots. In FIG. 7, n is an integer that is the number of collected snapshots. Generally, each snapshot is captured at a set time interval, such as every 500 ms to every few seconds. The snapshotting process itself takes minimal time. Accordingly, the data associated with a given snapshot is considered to be representative of a single point in time.

For example, in some implementations, snapshot A 710a may include time data 712a, physics data 714a, other data 716a, nearby player data 718a, and collided player data 720a. For example, the time data 712a may be an absolute time value or a relative time value. The time data 712a may help track when snapshot A 710a was acquired. Physics data 714a may include information about the user's avatar.

A valuable aspect of physics data 714a is that it is automatically reported by a client and is difficult to modify. Similarly, other data 716a may include other reported information that is automatically reported and is similarly reliable. Nearby player data 718a and collided player data 720a may also have this reliability property. FIG. 7 also illustrates that snapshot A 710a may be associated with a cheat probability of 0.85 that a cheat is occurring (as determined by the ML model). Hence, the model may determine that a cheat is detected if there is a threshold probability of, for example, 0.75 to detect a cheat.

Snapshot B 710b may have similar information as snapshot A 710a, including time data 712b, physics data 714b, other data 716b, nearby player data 718b, and collided player data 720b. FIG. 7 also illustrates that snapshot B 710b may be associated with a cheat probability analysis 722b of 0.6 that a cheat is occurring. Hence, the model may determine that a cheat is uncertain if there is a threshold probability of, for example, 0.75 to detect a cheat.

When detecting cheating, the detecting may check for abnormal data, such as abnormal avatar behavior, within a single snapshot. For example, if physics data 714a indicates an abnormal altitude, this may indicate that there may be a flying cheat associated with that single snapshot. However, it may also be possible to consider two consecutive snapshots or larger sets of snapshots.

By considering multiple snapshots, some implementations may be able to detect changes between snapshots that indicate cheating, even if individual snapshots do not show the cheating. The ML model may be trained to consider patterns in input data as input to the neural network. Then, the neural network may automatically generate a cheating likelihood that reflects such abnormal data. Moreover, abnormalities may be detected based on how data changes over time, not just abnormalities at single points in time.

For example, a speedhack may include modified motions that are not allowed, such as increased speed or acceleration. However, a speedhack could also involve unpermitted teleportation. Some implementations would find it difficult to identify teleportation from a single snapshot. However, if an avatar is in one position at a first snapshot and at another position in a subsequent snapshot in a way that is not explained by the user's velocity and acceleration, analyzing multiple snapshots could help detect a speedhack cheat. For example, in cheat probability analysis 722b, snapshot B by itself does not reliably allow detection of a cheat.

However, the ML model could also associate patterns in how the snapshots change over time, with respect to detecting cheating. For example, cheat probability analysis 722a illustrates a cheat probability of 0.85 and cheat probability analysis 722b illustrates a cheat probability of 0.6. However, window 724 reflects the window including snapshot A 710a and snapshot B 710b. This window 724 may have a separate label that indicates that comparing snapshot A and snapshot B yields a probability of 0.95 that is associated with the window. For example, the window may have a label of cheating, such as a label of a speedhack.

Considering the multiple snapshots by the neural network illustrates that the set of snapshots in a window as a whole indicate cheating in a way that would not be apparent from individual snapshots. While FIG. 7 illustrates a window of two consecutive snapshots, namely snapshot A 710a and snapshot B 710b, the windows may include more snapshots (the window could be three or more snapshots). Analyzing the snapshots in such windows allows the windows to be appropriately labeled with cheat likelihoods.

However, detecting a speedhack cheat is only one example of a cheat that could be detected by comparing multiple snapshots. For example, if scoring data or inventory data changes from snapshot to snapshot without explanation, that could also indicate a cheat. Hence, there may be a result of a 0.95 probability of a cheat for the window 724 because of an unexplained change in user position between snapshot A 710a and snapshot B 710b.

Snapshot N 71On may have similar information as snapshot A 710a, including time data 712n, physics data 714n, other data 716n, nearby player data 718n, and collided player data 720n. FIG. 7 also illustrates that snapshot N 71On may be associated with a cheat probability of 0.15 that a cheat is occurring. Hence, the model may determine that it is unlikely that a cheat is detected for snapshot N 710n if there is a threshold of, for example, 0.25, to detect no cheat. However, snapshot N 71On may be considered along with a window of other snapshots, and such windows may have a label associated with detecting cheating.

It may also be possible to make session-wide determinations with respect to cheating. For example, in some implementations the machine learning model may consider the data from snapshot A 710a through snapshot N 710n. The machine learning model may then make a global determination of the likelihood of cheating, no cheating, or likelihoods of particular cheats. In some implementations, the machine learning model may flag portions of the inputs, but not point to a specific element in the one input. Alternatively, the machine learning model may generate labels for every window (of some length) of snapshots, and as a result have a sequence of labels for a player in a given session. Such labels may pertain to cheating/no cheating or to specific forms of cheating.

For example, some implementations may provide cheat detection for a session 726. For example, FIG. 7 illustrates that cheating detection for the session 726 indicates that there is a cheat detected for the session with probability 0.8. Based on the threshold, the entire session may then be associated with cheating. Such cheating may be detected based on the overall behavior for the session. For example, the ML model may be trained to take into account all of the snapshots for the session 726 when making a cheat determination. Session 726 could reflect behaviors integrated into the ML as warning signs (such as the cheat information associated with snapshot A 710a and snapshot B 710b).

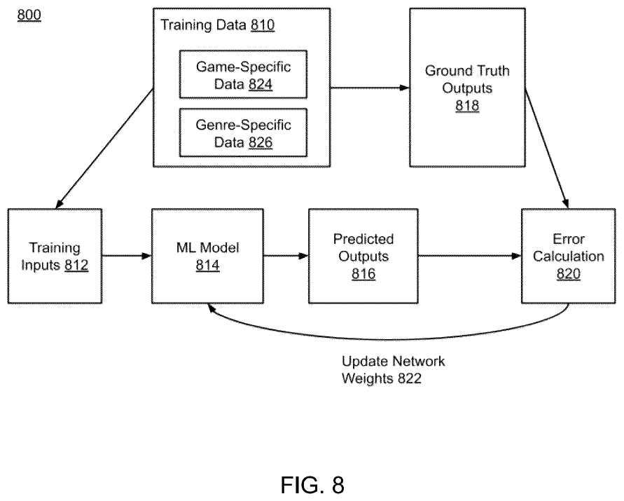

### FIG. 8—Example of Training Machine Learning Model

FIG. 8 is a diagram 800 of an example of training a machine learning model, in accordance with some implementations. In some implementations, the machine learning model may be a neural network. However, in some implementations, it may be possible to use other machine learning models, where the machine learning model associates a vector of numerical inputs with a vector of probabilities that provide likelihoods of cheating from the input vector. However, a neural network may be suitable for use herein because the neural network may map complicated assortments of data that change over time in nonlinear ways to corresponding outputs. The neural network may also model data that changes over time, in that some neural networks may consider a window of multiple snapshots over a time interval or multiple snapshots in a session rather than solely considering individual snapshots.

In some implementations, the neural network may be a feed-forward neural network. In some other implementations, the neural network may be a Recurrent neural network (RNN), a Long Short-Term Memory (LSTM) neural network, or a transformer neural network. An advantage of an RNN, an LSTM, or a transformer is that these architectures are adapted to identify changes in data over time and incorporate those changes into how models process input data.

For example, FIG. 8 begins with training inputs 812. Training inputs 812 may include vectors of game information at various time steps that have been flattened and serialized so the game information includes a suitable input for the ML model 814. Based on the training inputs 812, the ML model 814 may produce predicted outputs 816. However, the predicted outputs 816 may generally deviate from the ground truth outputs 818 before the ML model 814 is trained. Hence, there is an error calculation 820 that expresses the difference between predicted outputs 816 and the ground truth outputs 818. Based on the error calculation 820, the training updates network weights 822 to improve the performance of the ML model 814.

For example, in a feed-forward neural network (FNN), information flow is unidirectional (information in the model flows in only one direction). The model includes an input layer, at least one hidden layer, and an output layer. The nodes may be connected to one another, such that the input layer provides the inputs to the first hidden layer.

Each hidden layer takes a weighted sum of the outputs from the previous layer, applies an activation function, and passes the results to the next layer, until the information arrives at the output layer. Each neuron in one layer is connected to every neuron in the next layer, and each connection is associated with a weight. Learning updates the weights based on the error.

When training a feedforward neural network, there is a feedforward phase and a backpropagation phase. In the feedforward phase, the input data is fed into the neural network and propagated through the network, one layer at a time. At each layer, a weighted sum of the inputs is calculated, summed with a constant bias, and passed through an activation function to add non-linearity. The feedforward phase continues until the data reaches the output layer. Examples of activation functions include the sigmoid function, tanh, and ReLU (Rectified Linear Unit).

The backpropagation phase takes the prediction from the output layer and determines an error (difference between the predicted output and the actual output), based on using a loss function. The error may then be sent backwards through the network. In backpropagation, the weights between neurons are adjusted to minimize the errors that occur at the output layer. This minimization may use a gradient descent optimization algorithm (or other suitable technique). This algorithm moves the weights a small amount at a time in a way that may decrease the error, based on using gradients at each layer to find partial derivatives. By providing a set of training data as inputs and backpropagating accordingly, the weights take on values that minimize error. Further, it is possible to train based on all or part of the training data multiple times (referred to as epochs). Such repeated training allows the improvement of the performance of the model as much as possible.

In an RNN, the neural network may be distinguished from an FNN in that output from all or some neurons may affect the same nodes. Hence, information flow is bidirectional. For example, at least one layer may include at least one neuron that has an output that affects the same neuron. When training an RNN, it is still possible to use backpropagation. However, in an RNN, every neuron is assigned to a fixed time step. The neurons in the hidden layer may also be forwarded in a time step dependent direction. This means that the neurons are fully connected only with the neurons in the hidden layer with the same assigned time step. The neurons may also be connected with a one-way connection to every neuron assigned to the next time step. The input and output neurons may be connected only to the hidden layers with the same assigned time step.

The output of the hidden layer of a time step may be part of the input of the next time step. Hence, the activation of neurons may be computed in time order. At any given time step, only the neurons assigned to that time step compute their activation. Each layer's connections are associated with weight matrices, and the weight matrices may be associated with an error calculated using a loss function. The error, calculated using the loss function, is minimized by repeated forward propagation and backpropagation.

However, in an RNN, the forward propagation has to consider time steps. Also, the backpropagation is backpropagation through time (BPTT) that considers elements of the same time step and the memory state at the previous time step. However, an RNN may be subject to the vanishing gradient problem and training an RNN may be computationally expensive. The vanishing gradient problem refers to gradients that get very small as they are backpropagated, making it hard to effectively train an affected RNN.

An LSTM overcomes the vanishing gradient problem by using an LSTM unit in place of the hidden layer. An LSTM unit includes a cell state that conveys information through the sequence, a forget gate that manages what is relevant to retain, an input gate that manages what to consider from the current time step, and an output gate that decides the value of the output at a current time step. As opposed to RNNs, this enables LSTMs to handle long-term dependencies, e.g. large number of game snapshots. In an LSTM, the weight matrices are divided into submatrices that are connected to elements of the LSTM unit.

During training over all or some of the time steps, the gates of the LSTM learn which information is to be kept and which is to be forgotten. The gates may integrate such information or remove information from the cell state accordingly. In this way, an LSTM recovers data in a way that solves the vanishing gradient problem. Another type of RNN is a Gated Recurrent Unit (GRU). A GRU is somewhat similar to an LSTM, except that a GRU uses a reset gate, an update gate, and a memory.

In a transformer neural network, the neural network may rely on the parallel multi-head attention mechanism. A transformer is known for allowing for parallel computation and for capturing long range dependencies more effectively than other recurrent neural networks. Transformers have certain main components, which may include tokenizers, a single embedding layer that converts tokens and positions of tokens into vector representations, transformer layers, which carry out transformations on the vector representations, extracting information from the vectors, and an optional un-embedding layer, which converts the final vector representations back to a probability distribution over the tokens. Here, the tokenizing and the embedding layer functions may be performed during the preprocessing. Such preprocessing includes flattening and serialization that provides a vector for the transformer layers.

A transformer may use an encoder-decoder architecture. That is, the transformer layers may include encoder layers, decoder layers, or both. For example, the transformer may be built from scale dot-product attention units. For each attention unit, the transformer model learns three weight matrices: query weights, key weights, and value weights. The set of weight matrices is called an attention head. There may be multiple attention heads that capture attention between tokens in the layers.

An encoder layer may include a self-attention mechanism and a feed-forward neural network. A decoder layer may include a self-attention mechanism, an attention mechanism over the encodings, and a feed-forward neural network. The decoder operates in a similar way to the encoder, but an additional attention mechanism is inserted which instead draws relevant information from the encodings generated by the encoders.

A transformer neural network may be encoder only (full encoder, full decoder), encoder-decoder (full encoder, autoregressive decoder), or decoder only (autoregressive encoder, autoregressive decoder). Once trained, the transformer neural network may use patterns in data at each point in time and statistical relationships in the data that capture how changes in the data over time influence each other and indicate properties of the data such as indicating cheating. Transformers may also be well suited for unsupervised or semi-supervised learning that can train a model based on patterns in data even if the data is not fully labeled.

FIG. 8 illustrates an example of training that may occur when the machine learning model's training is supervised. Supervised training means that the training data includes examples of inputs and corresponding ground truth outputs. For example, FIG. 8 illustrates training data 810. In some implementations, the training data 810 may include game-specific training data 830 or genre-specific training data 832. If the training data 810 used is game-specific training data 830, ML model 814 may identify cheats for that particular game effectively. If the training data 810 used is genre-specific training data 832, ML model 814 may identify cheats for that particular genre of games effectively. Such training may improve the accuracy and precision (or other performance) of the ML model 814 for the particular game or genre. The training may also improve the ability of the ML model 814 to effectively identify particular cheats that are relevant to particular game or genre.

In some implementations, the ML model 814 may be utilized to detect cheating for any game. However, cheating signs and indicators may vary widely between games and genres. Hence, it may be more effective to use game-specific training data 830 or genre-specific training data 832. Also, game-specific training data 830 or genre-specific training data 832 is specific to a particular game or genre of games.

Hence, the ML model 814 may also be constructed in a way that the training data is particularly useful at detecting types of cheats that are more common or relevant to the particular game or genre. For example, flying cheats may be challenging to detect in a game that allows flying. A relevant ML model 814 may be trained to identify such cheating. However, flying cheats may be irrelevant in a game where the game itself includes flying avatars. A ML model 814 may take into account which users are supposed to have flying avatars.

To deal with in-game situations in which behaviors that would otherwise indicate cheating, there may be an opt-in feature that would modify whether cheating is detected in a given game. Alternatively, there may be an opt-in feature that would control which cheats are detected. In some implementations, it could also be possible to have in-game calibration. For example, game characteristics could specify whether flying is permitted or not. Thus, a flying cheat detected by an ML model may be ignored for games where flying is permitted (as a post-processing step, or during model training). As an alternative, if all or most players are marked as cheating even on trusted data sources, this may indicate that the cheating detection is looking for the wrong evidence and the cheating determination may be overridden.

In order to train the machine learning model, there may be a benefit from having labeled training data. At present, there is no labeled training data available that associates available behavioral data with corresponding occurrences of cheating. One way to generate appropriate data would use a team (customarily called a red team). Such a team pretends to be a group of users attempting to cheat. The team may mimic various cheats, and their interactions with the system may be recorded. This interaction may generate data that indicates cheating. Another possible way to generate data, performed in some implementations, would be to use bot-based data (where the bots take on the role of users attempting cheating and their behavior is linked to the cheating).

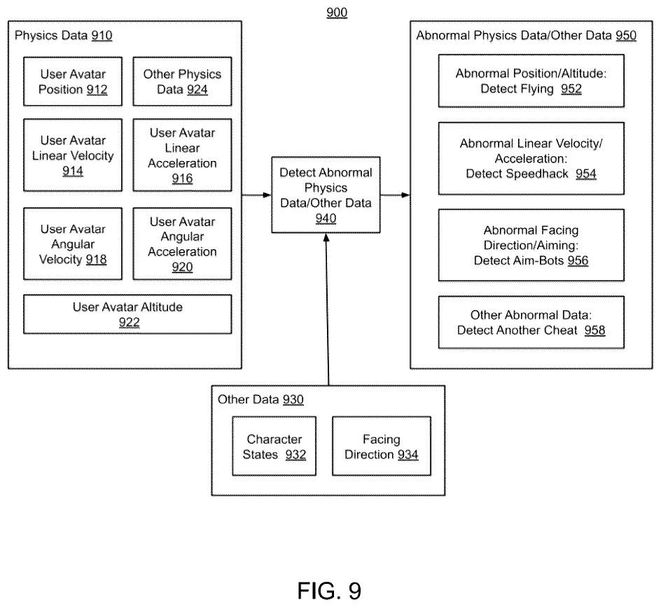

### FIG. 9—Example of Detecting Abnormal Avatar Behavior

FIG. 9 is a diagram of an example of detecting abnormal avatar behavior 900 as a sign of cheating, in accordance with some implementations. In some implementations, there may be a set of physics data 910. The physics data 910 may be received from a client device. For example, the physics data 910 may include user avatar position information 912, user avatar linear velocity information 914, user avatar linear acceleration information 916, user avatar angular velocity information 918, user avatar angular acceleration information 920, and user avatar altitude information 922. However, these are only illustrative examples of physics data 910 and other types of physics data 924 may also be provided, in some implementations. For example, there may be state information about variables associated with a user and the user's avatar, such as Health, MoveDirection, Rotation, Transparency, etc.

The client device may also provide certain other data 930 for cheat detection. For example, the other data 930 may include character states information 932 or facing direction information 934. Hence, FIG. 9 illustrates that the physics data 910 and the other data 930 are provided to a module 940 to detect abnormal physics data or other data. FIG. 9 also illustrates that module 940 identifies abnormal physics data and/or other data in module 950. For example, module 940 may correspond to the ML model, which has learned to associate patterns of abnormal physics data 910 and/or other data 930 with cheating.

In some implementations, module 950 detects abnormal user avatar position 912 or abnormal user avatar altitude 922 at 952. If this information indicates a user avatar positioned above the ground, having an abnormal position/altitude, etc., module 950 may detect flying 952. This position information may be based on a single snapshot, or on changes between multiple snapshots.

In some implementations, module 950 detects abnormal user avatar linear velocity 914 or abnormal user avatar linear acceleration 916 at 952. If this information indicates a user avatar moving faster than the game physics allows, having an abnormal velocity/acceleration, etc., module 950 may detect a speedhack 954. However, detecting the speedhack 954 may not be limited to considering a single snapshot of physics data. For example, if user avatar position 912 indicates a certain position at a first time and another position at a second time, and the change of position is not consistent with the user's motion measurements or exceeds a change of distance associated with the game's physics, there may still be a detected speedhack 954.

In some implementations, module 950 detects a facing direction 934 associated with automatically aiming a weapon or shooting another avatar at 956. If this information indicates a user avatar facing another user, and the faced user is automatically targeted, shot, injured in an unpermitted manner, and/or killed, module 950 may detect aim-bots 956.

In some implementations, module 950 detects other abnormal data at 958. If the physics data 910 and/or the other data 930 information indicates a user directing an avatar to do something that violates the rules of the game, module 950 may detect another corresponding cheat 958. For example, if the information indicates a user's avatar affecting the position of another user's avatar in an illegal way, this may be considered an interaction cheat. However, this is only an example. In general, the ML model may learn from its training which patterns of behaviors indicate cheating. Accordingly, when those patterns actually occur, the ML model may indicate the presence of cheating.

Thus, cheating may sometimes be detected based on interactions between avatars. For example, the implementations may consider an avatar's nearby avatars and touched avatars, which may be included in the snapshots. In some implementations, the snapshots may also include terrain information.

Certain other interactions between avatars (other than collisions) could indicate cheating. Such interactions could be based on the snapshots and could characterize interactions that indicate that basic rules of a given game are being violated. For example, if whenever a player's avatar looks at another player's avatar, other players' avatars in that direction just die or are wounded, this could indicate aim-bot behaviors in games that do not specifically include automatic aiming. As another example, if some touched or nearby avatars of an avatar have abnormal speed or other abnormal movement characteristics, there might be cheating in which a cheating user's avatar is pushing other users off the map (which may be a type of interaction cheat).

Another aspect of using a machine learning model is model evaluation. The model evaluation could include offline model evaluation and/or online model evaluation. In some implementations, offline model evaluation could include evaluating the model for standard metrics such as precision, recall, F-score, and so on. There could also be a custom metric specific to particular games that gives a higher weight to False Negatives (FN) or to certain types of cheats.

In some implementations, a machine learning model may be tested by periodically injecting test cheats into the system to validate for the presence of FNs. When FNs occur, the machine learning model may be altered to add new features or retrain the model with new samples for that particular cheat. As games evolve, there may be new types of cheating and/or indicators of cheating. The model may be augmented or re-trained to reflect these changes. Also, in some implementations, there may be a monitoring if positive and negative rates align with expectations. In some implementations, it may also be helpful to experiment with trusted platforms that are believed to include no cheating to evaluate or calibrate a model to confirm that no cheating is predicted by the model.

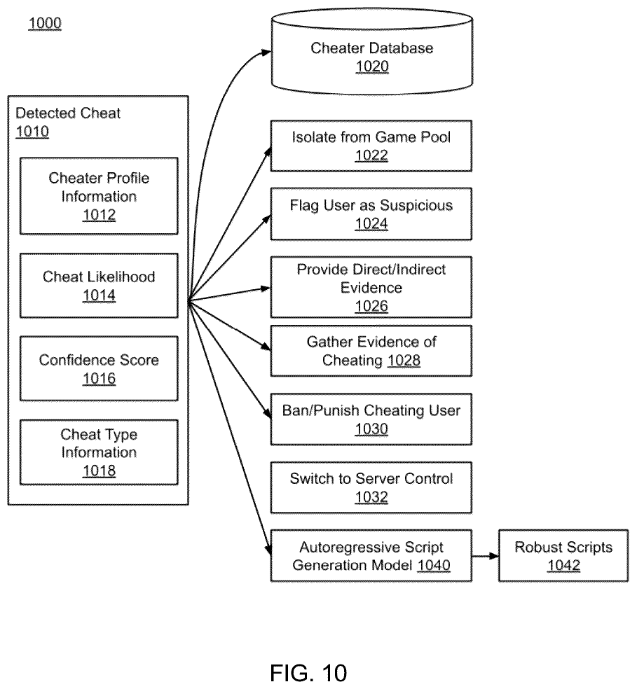

### FIG. 10—Examples of Anti-cheat Operations

FIG. 10 is a diagram 1000 of anti-cheat operations, in accordance with some implementations. For example, FIG. 10 illustrates that, in some implementations, there may be a set of information associated with a detected cheat information 1010. For example, the detected cheat information 1010 may include cheater profile information 1012, cheat likelihood information 1014, confidence score information 1016, and cheat type information 1018.

The detected cheat information 1010 may be used in a variety of possible anti-cheat responses. In response to the cheating analysis data indicating with a likelihood exceeding a threshold probability that a user is cheating, some implementations may perform an anti-cheat operation. Other implementations may perform an anti-cheat operation based on other triggering conditions. Some implementations may also gather information about the likelihood and characteristics of a potential cheating activity. For example, all or some of the detected chat information 1010 may be stored in a cheater database 1020. Alternatively, or in addition to storing the detected chat information 1010, there may be actions that some implementations use as responsive measures to a detected cheat. Such actions could occur automatically or based on human intervention.

For example, a detected cheater may be isolated from the game pool 1022. Alternatively, a detected cheater may be flagged as suspicious 1024. The flag could associate the detected cheater with a particular cheat or cheats. Alternatively, the detected cheat information 1010 could be used to provide direct or indirect evidence for affecting a user 1026. Also, the output could be used to gather evidence of cheating 1028. Alternatively, a cheating user could be banned and/or punished 1030.

In another alternative, the detected cheat information 1010 could indicate that all or some of client-based game-logic execution is to be shifted to server-based execution 1032 when possible, to stop execution of client-based instructions that otherwise would interfere with game operations and cause cheating. When there is server authority in place, the server does not trust client simulation and instead only accepts client keyboard/mouse/touch inputs.

As yet another alternative, the detected cheat information 1010 could be provided to an autoregressive script generation model 1040. The autoregressive script generation model 1040 could generate robust scripts 1042. For example, a cheat flag and game scripts, along with the user profile/avatar action and additional features may be used as input to the autoregressive script generation model 1040 and the autoregressive script generation model 1040 could then generate scripts robust to that particular cheat. In some implementations, such robust scripts could be obtained from the autoregressive script generation model 1040, such as by a game server. The scripts could then be executed in the virtual environment.

While it may be possible for some implementations to use in-game chat as a signal to detect cheating behavior, other implementations are limited to detecting cheating behaviors based on game-state-only behavior. If cheating detection is based on such game-state-only behavior, this may make it easier for downstream operations to combine multiple independent cheat detectors to make decisions.

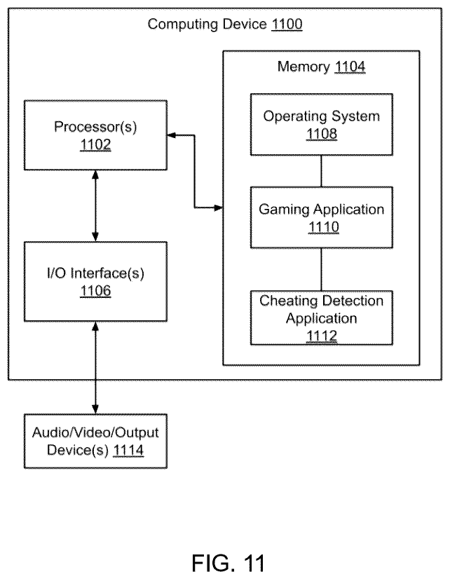

### FIG. 11—Computing Device

FIG. 11 is a block diagram of an example computing device 1100 which may be used to implement one or more features described herein. In one example, device 1100 may be used to implement a computer device (e.g. 102 and/or 110 of FIG. 1), and perform appropriate method implementations described herein. Computing device 1100 can be any suitable computer system, server, or other electronic or hardware device. For example, the computing device 1100 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 1100 includes a processor 1102, a memory 1104, input/output (I/O) interface 1106, and audio/video input/output devices 1114.

Processor 1102 can be one or more processors and/or processing circuits to execute program code and control basic operations of the device 1100. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1104 is typically provided in device 1100 for access by the processor 1102, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1102 and/or integrated therewith. Memory 1104 can store software operating on the server device 1100 by the processor 1102, including an operating system 1108, one or more gaming applications 1110, e.g., a cheat detection application 1112. In some implementations, gaming applications 1110 can include instructions that enable processor 1102 to perform the functions (or control the functions of) described herein, e.g., some or all of the methods described with respect to FIG. 5.

For example, gaming applications 1110 can include a cheat detection application 1112, which as described herein can provide cheat detection within an online virtual experience server (e.g., 102). Elements of software in memory 1104 can alternatively be stored on any other suitable storage location or computer-readable medium. In addition, memory 1104 (and/or other connected storage device(s)) can store instructions and data used in the features described herein. Memory 1104 and any other type of storage (magnetic disk, optical disk, magnetic tape, or other tangible media) can be considered “storage” or “storage devices.”

I/O interface 1106 can provide functions to enable interfacing the server device 1100 with other systems and devices. For example, network communication devices, storage devices e.g., memory and/or data store 120), and input/output devices can communicate via I/O interface 1106. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1114 can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 11 shows one block for each of processor 1102, memory 1104, I/O interface 1106, and software blocks of operating system 1108, gaming applications 1110, and cheat detection application 1112. These blocks may represent one or more processors or processing circuitries, operating systems, memories, I/O interfaces, applications, and/or software engines. In other implementations, device 1100 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 1100, e.g., processor(s) 1102, memory 1104, and I/O interface 1106. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1114, for example, can be connected to (or included in) the device 1100 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

We claim:

1. A computer-implemented method to detect cheating in a virtual experience, the method comprising:
obtaining game information comprising game state information; and
generating, by a trained machine learning (ML) model and based on the game information, output that characterizes user behaviors in the virtual experience, wherein the output includes cheating analysis data that characterizes the user behaviors by indicating a cheating likelihood for one or more users.

2. The method of claim 1, wherein the trained ML model is trained using supervised learning using training data pre-generated during cheating scenarios.

3. The method of claim 1, wherein the trained ML model is game-specific or genre-specific.

4. The method of claim 1, wherein the cheating analysis data is associated with a confidence score.

5. The method of claim 1, wherein the trained ML model is a single ML model that generates a plurality of labels, each label corresponding to a particular type of cheating, or the trained ML model includes a plurality of activity-specific ML models, wherein each activity-specific ML model is a respective label corresponding to a particular type of cheating.

6. The method of claim 1, further comprising preprocessing the game information prior to the generating by flattening the game information and serializing the game information into a vector of numbers.

7. The method of claim 1, wherein the game information comprises time data and user avatar physics data, and indicates cheating when the user avatar physics data comprises values that violate one or more physics rules of the virtual experience.

8. The method of claim 1, wherein the cheating analysis data comprises a plurality of likelihoods, each likelihood corresponding to a particular type of cheating.

9. The method of claim 1, wherein the cheating analysis data comprises a cheating likelihood label for each time window of a predetermined length.

10. The method of claim 1, wherein a time window associated with a threshold number of consecutive cheat labels in the cheating analysis data, each cheat label indicating prohibited behavior, is determined as indicating prohibited behavior for the time window.

11. The method of claim 1, further comprising, in response to the cheating analysis data indicating with a likelihood exceeding a threshold probability that a user is cheating, performing an anti-cheat operation.

12. The method of claim 1, further comprising providing the cheating analysis data and game scripts to a language model for program synthesis to generate scripts robust to a type of cheating associated with the cheating analysis data.

13. A non-transitory computer-readable medium comprising instructions that, responsive to execution by a processing device, causes the processing device to perform operations comprising:
obtaining game information comprising game state information; and
generating, by a trained machine learning (ML) model and based on the game information, output that characterizes user behaviors in a virtual experience, wherein the output includes cheating analysis data that characterizes the user behaviors by indicating a cheating likelihood for one or more users.

14. The non-transitory computer-readable medium of claim 13, the operations further comprising preprocessing the game information prior to the generating by flattening the game information and serializing the game information into a vector of numbers.

15. The non-transitory computer-readable medium of claim 13, the operations further comprising, in response to the cheating analysis data indicating with a likelihood exceeding a threshold probability that a user is cheating, performing an anti-cheat operation.

16. The non-transitory computer-readable medium of claim 13, wherein the trained ML model is a single ML model that generates a plurality of labels, each label corresponding to a particular type of cheating, or the trained ML model includes a plurality of activity-specific ML models, wherein each activity-specific ML model is a respective label corresponding to a particular type of cheating.

17. A system comprising:
a memory with instructions stored thereon; and
a processing device, coupled to the memory, the processing device configured to access the memory and execute the instructions, wherein the instructions cause the processing device to perform operations including:
obtaining game information comprising game state information; and
generating, by a trained machine learning (ML) model and based on the game information, output that characterizes user behaviors in a virtual experience, wherein the output includes cheating analysis data that characterizes the user behaviors by indicating a cheating likelihood for one or more users.

18. The system of claim 17, the operations further comprising preprocessing the game information prior to the generating by flattening the game information and serializing the game information into a vector of numbers.

19. The system of claim 17, the operations further comprising, in response to the cheating analysis data indicating with a likelihood exceeding a threshold probability that a user is cheating, performing an anti-cheat operation.

20. The system of claim 17, wherein the trained ML model is a single ML model that generates a plurality of labels, each label corresponding to a particular type of cheating, or the trained ML model includes a plurality of activity-specific ML models, wherein each activity-specific ML model is a respective label corresponding to a particular type of cheating.
